(19) United States
(12) Patent Application Publication
(10) Pub. No.: US 2017/0293599 A1
(43) Pub. Date: Oct. 12, 2017

(54) Checklist Contexts and Completion

(71) Applicant: Microsoft Technology Licensing, LLC, Redmond, WA (US)

(72) Inventors: Dan Driscoll, Seattle, WA (US); Thomas Matthew Laird-McConnell, Kirkland, WA (US)

(21) Appl. No.: 15/092,611

(22) Filed: Apr. 6, 2016

(51) Int. Cl. G06F 17/24; G06F 17/21

(52) U.S. Cl. CPC G06F 17/243; G06F 17/218; G06F 17/248

(57) ABSTRACT

Systems, methods and computer-readable media are presented for processing a checklist from a checklist template. In contrast to typical checklist processing, the disclosed embodiments include a checklist instance, generated from a checklist template, which includes structured data storage, unstructured data storage, a checklist, and an execution state. Upon an indication to pause execution of the checklist, the checklist instance is stored in a data store such that, upon resumption of execution, the values of the structured, unstructured, and execution state are restored. Upon detecting that an executed checklist item corresponds to markup content, an analysis of the markup content is made to identify entry fields within the content that correspond to structured data fields of the checklist instance. Entry fields with a corresponding field in the checklist can be prepopulated with the values of the checklist data fields.

### BACKGROUND

There are many instances, especially in business, where a checklist is used to carry out a specific set of tasks for some desired purpose. For example, when a new person is hired into a company, that company will typically have a checklist of actions or activities to perform on behalf of that newly-hired person so that the new employee can function within the company. Examples of these actions/activities may include capturing relevant information regarding the new employee (e.g., name, hire date, position, payment information, etc.), assigning an employee number and security access card, granting access permissions, assigning a workspace, ordering furniture and equipment, enrolling in insurance and employee benefits, and the like. Often, these checklists are substantial and require more than a few moments of time to complete. Indeed, simply gathering the relevant information may take some effort as some part of the information may be provided by email, some by phone, some via in-person discussion, and the like. As such and due to the nature of business, it is very likely that a person completing a new-employee checklist, or, more generically, any given checklist, will be interrupted: maybe for a few minutes, maybe overnight, maybe over the weekend, or more. Further still, it may also be likely that a first person that begins a checklist may turn the task over to a second person to complete the task. Unfortunately, when relevant information for the completion of a checklist is found in or available through multiple sources, or completed my multiple parties, there is substantial time lost in re-aggregating relevant information upon resuming a checklist after some pause or transition.

Additionally, as those skilled in the art will appreciate, each business will typically have a set of software applications/tools that the business uses to carry out various activities. Unfortunately, while there is much effort spent on creating a central repository for information and tying all tools to that repository, the fact is that most of these software applications/tools operate independently of the others, resulting in some redundancies. Often one will hear a complaint, “I entered that data earlier, why is it asking for me to enter it again?” In the context of a checklist, this can happen frequently and is exacerbated when a pause occurs during the checklist completion and needs to be re-acquired.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, systems, methods and computer-readable media are presented for processing a checklist from a checklist template. In contrast to typical checklist processing, the disclosed embodiments include a checklist instance, generated from a checklist template, which includes structured data storage, unstructured data storage, a checklist, and an execution state. Upon an indication to pause execution of the checklist, the checklist instance is stored in a data store such that, upon resumption of execution, the values of the structured, unstructured, and execution state are restored. Upon detecting that an executable checklist item corresponds to markup content, an analysis of the markup content is made to identify entry fields within the content that correspond to structured data fields of the checklist instance. Entry fields with a corresponding field in the checklist can be prepopulated with the values of the checklist data fields.

According to additional aspects of the disclosed subject matter, a computer-implemented method for executing a checklist according to a checklist instance is presented. A checklist instance is generated/created from a checklist template, where the checklist instance comprises one or more fields and a checklist comprising a plurality of checklist items for execution. After executing at least a first checklist item of the plurality of checklist items, where execution of the first checklist item causes an update to a first checklist field, a first instruction to suspend execution of the checklist is received. In response to the instruction, the current state of the checklist instance is stored in a data store. Storing the current state of the checklist instance in a data store comprises storing the first checklist field as part of the checklist instance. A second instruction to resume execution of the checklist with regard to the checklist instance is received. Upon receiving the second instruction, the checklist instance is retrieved from the data store and at least one additional checklist item of the checklist is executed.

According to further aspects of the disclosed subject matter, a computer-readable medium bearing computer-executable instructions is presented. When executed on a computing system comprising at least a processor retrieved from the medium, the computer-executable instructions carry out a method comprising at least creating a checklist instance from a checklist template. The created checklist instance comprises one or more checklist fields to be set and further comprises a checklist comprising a plurality of checklist items. At least a first checklist item of the plurality of checklist items is executed, and that execution of the first checklist item causes an update to a first checklist field. A first instruction to suspend execution of the checklist is then received and, in response, the current state of the checklist instance is stored in a data store. Storing the current state of the checklist instance in a data store comprises storing all checklist fields, including the first checklist field, as part of the checklist instance. After storing the current state of the checklist instance in a data store, execution of the checklist is suspended. A second instruction to resume execution of the checklist with regard to the checklist instance is received, and in response the checklist instance is retrieved from the data store and at least one additional checklist item of the checklist is executed. Executing a checklist item of the checklist comprises at least determining that the execution of the at least one checklist item is in regard to markup content; analyzing the markup content to identify entry fields of the markup content; correlating an identified entry field of the markup content to a checklist field of the checklist instance; and prepopulating the entry field of the markup content with the current value of the checklist field.

According to still further aspects of the disclosed subject matter, a computer system for processing a checklist instance in presented. The system comprises a processor and a memory, wherein the processor executes instructions stored in the memory as part of or in conjunction with additional components including a checklist execution module. In operation, the checklist execution module generates a checklist instance from a checklist template. Further the checklist execution module executes at least a first checklist item of a checklist of the checklist instance. In response to receiving an instruction to suspend the execution of the checklist, the checklist execution module stores the current state of the checklist instance and suspends execution of the checklist. Upon receiving an instruction to resume the execution of the checklist, the checklist execution module retrieves the stored state of the checklist instance and resumes execution of the checklist, where resuming the execution of the checklist comprises executing at least a second checklist item of the checklist.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a block diagram of an exemplary network environment suitable for implementing aspects of the disclosed subject matter;

FIG. 2 is a flow diagram of an exemplary routine for generating a checklist template according to aspects of the disclosed subject matter;

FIG. 3 is a flow diagram of an exemplary routine for executing a checklist according to a checklist template;

FIG. 4 is a flow diagram of an exemplary routine for executing a checklist of a checklist instance, based on a checklist template and according to aspects of the disclosed subject matter;

FIG. 5 is a flow diagram of an exemplary routine for executing checklist items of a checklist in accordance with aspects of the disclosed subject matter;

FIG. 6 a flow diagram of an exemplary routine for executing a checklist item, particularly a checklist item corresponding to auto-completion of fields of a web page, in accordance with aspects of the disclosed subject matter;

FIG. 7 is a block diagram illustrating an exemplary computer readable medium encoded with instructions to operate a search engine according to aspects of the disclosed subject matter;

FIG. 8 is a block diagram illustrating an exemplary user computing device configured according to aspects of the disclosed subject matter; and

FIG. 9 is a flow diagram illustrating an exemplary routine for creating a checklist template from an existing checklist instance.

### DETAILED DESCRIPTION

For purposes of clarity, the use of the term “exemplary” in this document should be interpreted as serving as an illustration or example of something, and it should not be interpreted as an ideal and/or leading illustration of that thing. Stylistically, when a word or term is followed by “(s)”, the meaning should be interpreted as indicating the singular or the plural form of the word or term, depending on whether there is one instance of the term/item or whether there is one or multiple instances of the term/item. For example, the term “user(s)” should be interpreted as one or more users.

By way of definition, a “checklist template” is a template corresponding to a checklist of one or more checklist items. A “checklist item” is an action to be taken as an element of a checklist. As will be described in greater detail below, a checklist template includes or references a corresponding set of checklist items, information regarding structured data, information regarding unstructured data, information regarding an execution status, and the like. As a template, a checklist template does not necessarily include some or any data fields, though it may. More importantly, however, a checklist template represents a pattern/template for the data fields that will be included in an instance of the template, i.e., a checklist instance. Additionally, a checklist template may include template data that is generic to all checklist instances of a particular checklist template.

As indicated above, a “checklist instance” is an instantiation of a checklist template, instantiated with regard to a particular entity or purpose. A checklist instance includes or references the corresponding set of checklist items of the checklist template, and further includes the structured and unstructured data identified in the checklist template. Regarding the structured data, structured data corresponds to data whose structure and/or purpose is known. Structured data may in include, by way of illustration and not limitation, tables, numeric values, Boolean values, strings, characters, ordinal values, and the like. Each of the values, as created in a checklist instance, corresponds to a field. Typically, each field may be identified a field name by which the field may be understood. However, while fields may be referenced by a field name, field names are typically not included within a checklist instance. For example, a particular field of structured data within a checklist instance may correspond to a person's first name. The field name for that field may be, “First Name” and the field in the checklist instance may be configured to hold a person's first name, but the field name is not necessarily stored in the checklist instance.

Unlike structured data, unstructured data comprises data and/or content that is not identified in the checklist template. As mentioned above, a checklist template may indicate that an unstructured data area is to be a part of a checklist instance generated from the template. Also, the checklist template may identify particular items of content/data that are to be initially included within the unstructured data area of a checklist instance. Computer users may also add data and/or content to the unstructured data area of a checklist instance. By way of example, a new employee checklist template may exist with regard to on-boarding new employees into a company. A new employee checklist instance is generated from a new employee checklist template with regard to a particular person. In contrast to a new employee checklist template, a new employee checklist instance will, at various stages of completion, include information regarding the new employee/person such as a name, a home address, a hire date, an employee number, etc.

By way of definition, a markup or form document should be viewed as content that includes one or more identified fields that can receive data. Examples of form documents include, by way of illustration and not limitation, PDF (Portable Document Format) files, HTML (HyperText Markup Language) files/documents/pages, XML (Extensible Markup Language) files/documents/pages, and the like. As will be discussed in greater detail below, in regard to form documents, these documents/files can be examined to identify data fields within the content, correlate the data fields to the structured data fields of a checklist instance, and pre-populate/autocomplete those fields with and currently available information within the checklist instance.

As mentioned above, quite often though not exclusively, in a business context checklists may be substantial and require more than a few moments to complete, and/or are completed by multiple people. Indeed, gathering or aggregating the information to complete or more checklist items (individual, discrete steps of a checklist) may take significant effort and time. Some information may be made provided by email, some by phone or an in-person discussion, some information may be distributed among various sources, and the like. As such, it is very likely that a person completing a checklist will be interrupted during the course of completing the checklist. Such interruption may be for a few minutes and prove to be only a slight interruption that doesn't significantly distract the person executing the checklist from the desired task. However, many interruptions are much more significant: some interruptions in checklist completion may cause an overnight delay, a delay over several days and/or over a weekend, a holiday, a vacation, or more. Unfortunately, in current practice, quite often relevant information for the completion of a checklist is found in or available through an aggregation of multiple sources, such as email, telephone conversations, internal tools, and the like. Thus, there is a substantial amount of time that is lost, as a result of an interruption, in the re-acquisition of relevant information upon resuming the completion of a checklist.

In contrast to the current practice of simply aggregating information in one's email/office productive software and/or personal notes and wherever else one might store information, a checklist is embodied within a checklist instance generated from a checklist instance. According to aspects of the disclosed subject matter, when a checklist is executed based on a checklist template, a checklist instance is created, where the checklist instance includes data fields (structured data) that store defined/known values and content storage (unstructured data) in which acquired content is stored and persisted. By persisting the data, either locally one the computing device of the person executing the checklist or remotely, interruptions and pauses in the checklist execution are not impacted: the information that is input and aggregated into the checklist instance is preserved and execution can be readily resumed.

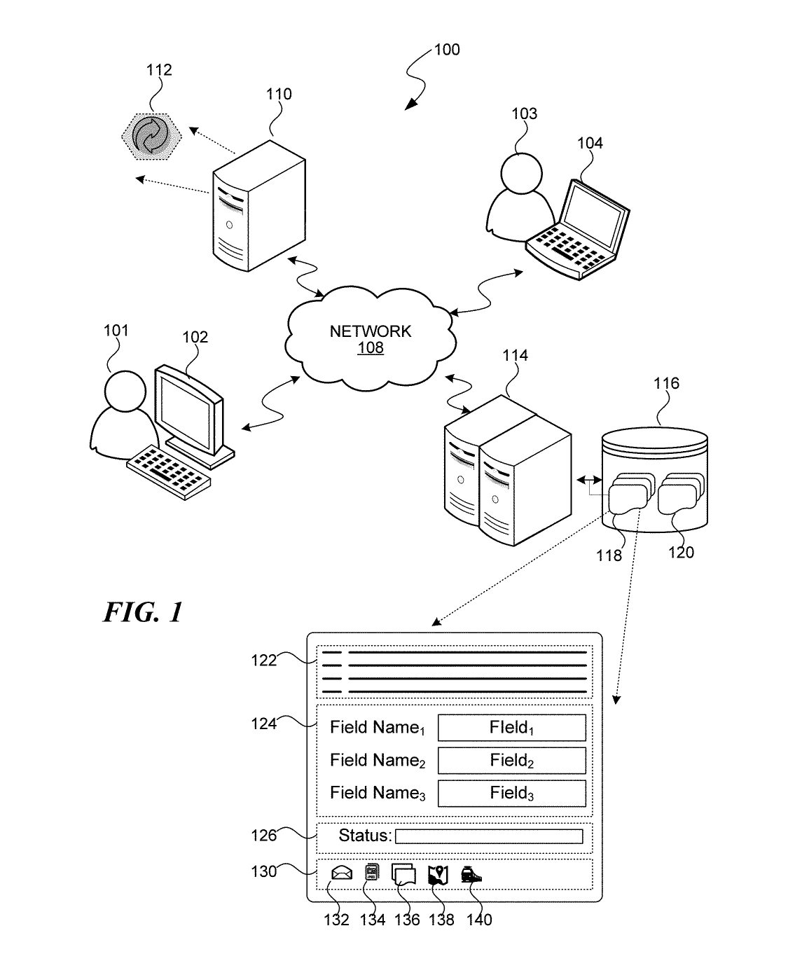

Turning to the figures, FIG. 1 is a block diagram illustrating an exemplary network environment 100 suitable for implementing aspects of the disclosed subject matter, particularly in regard to executing checklists, persisting checklist data, and in form completion. The network environment 100 includes a user computer 102, corresponding to a computer user 101 that (for purposes of this discussion) is executing a checklist as found in checklist instance generated from a checklist template. As suggested above, the computer user 101 accesses a checklist template and, in execution, creates a checklist instance with regard to some entity or purpose. The entity, according to aspects of the disclosed subject matter, may correspond to a person, an organization, the completion of a task, and the like and without limitation. While a checklist template describes information regarding what is to be captured (data values) and what checklist items/steps are carried out, in executing the checklist template, a checklist instance is created that includes storage for the defined fields (i.e., structured data, data items that each have a defined meaning) and a storage area for unstructured data.

In regard to the user computer 102, while a desktop terminal is illustrated, it should be appreciated that any suitable computer or computing device may be employed including, by way of illustration and not limitation: desktop computers (sometimes referred to as personal computers), laptop computers, tablet computers, mini- and/or mainframe computers, smart phones, personal digital assistants, and the like. Generally speaking, a suitable user computer or computing device includes a processor suitable for executing the checklist items of a checklist of a checklist instance, memory for storing data values as gathered throughout the checklist execution process, access and ability to invoke services for carrying out the various checklist items, the ability to persist a checklist instance, either locally or remotely, and resume execution based on a persisted checklist instance.

The network environment 100 further includes other network computing devices and/or services, such as (by way of illustration and not limitation) a remote user computer 104, an online service 112 hosted on remote computing device 110, a checklist store computing device 114 that hosts a checklist store 116 storing both checklist templates 120 and checklist instances 118, each interconnected by way of a network 108. As will be readily appreciated, the network 108 may comprise any of one or more WANs (wide area networks, i.e., a telecommunications network or computer network that extends over a large geographical distance) such as the Internet, one or more LANs (local area networks, i.e., a telecommunications network or computer network that interconnects computers within a limited area such as a residence, school, laboratory, or office building, etc.) or a combination of the two.

Regarding a checklist instance, each checklist instance comprises (or references) a set of computer-executable checklist items 122 for carrying out the desired, overall task of the checklist. Each checklist instance further comprises structured data, i.e., a set 124 of fields, each field having a known purpose and suitable for storing data (irrespective of whether or not the value of that field has been set or not). Of course, while the set 124 of structured fields shows a name (e.g., “Field Name₁” corresponding to “Field₁”), this is for illustration purposes and is typically not included in an actual checklist instance.

In addition the set of checklist items 122 and structured data 124, each checklist instance further comprises an unstructured data store 130 into which content (e.g., email 132, documents 136, images 134, maps 138, transit data 140, and the like) that may be relevant to the corresponding checklist instance and/or desirable to be saved/stored with the checklist instance may be placed. For example, a person completing a new employee hire may receive an email message from the new employee regarding various items of information. Rather than simply “remember” that the new employee has sent information via an email and forcing the person completing the new employee task to refer back to that email when completing the form, that person can place the email containing information regarding the new employee in the checklist instance that is created. In addition to adding information at the time of completing a checklist instance, standard information, such as maps of company buildings, transit information, company policies, and the like may be placed in the unstructured data set of a checklist template, such as checklist template 120, so that it is always present when completing a given checklist. Further still, a checklist instance, such as checklist instance 118, will also typically include a status value 126 that indicates the current progress through the checklist items of the checklist instance.

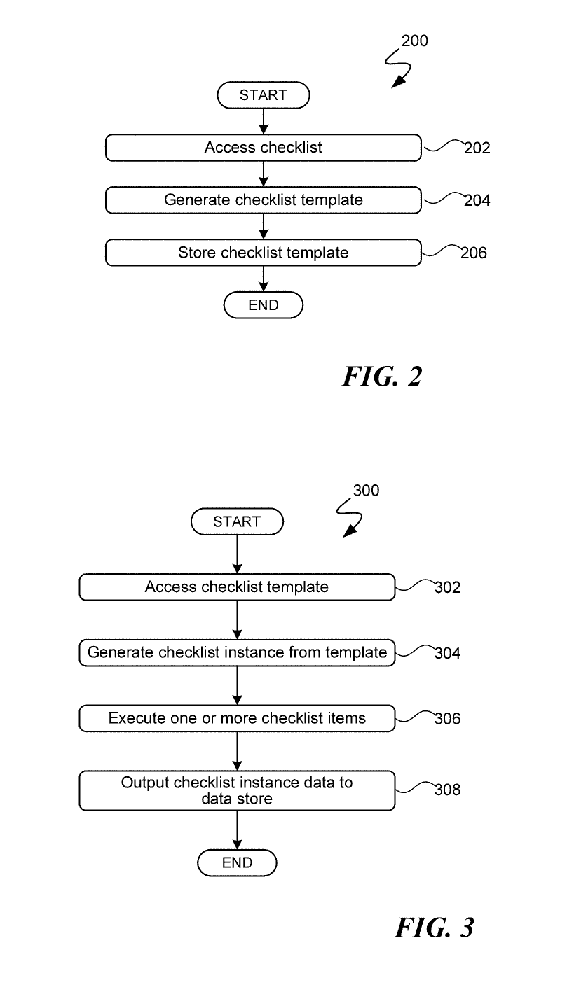

Turning to FIG. 2, FIG. 2 is a flow diagram of an exemplary routine 200 for generating a checklist template according to aspects of the disclosed subject matter. Beginning at block 202, a checklist comprising computer executable checklist items is accessed. These executable checklist items may comprise, by way of illustration and not limitation: resource references (typically but not exclusively as URLs/references) to form documents; references to applications and/or services, including local and/or remote applications and services; executable scripts or code; and the like. Through the execution of the various services, apps, applications, code and/or script modules that comprise the checklist items, data values corresponding to the checklist can be persisted within the checklist instance, such as checklist instance 118.

Based on the accessed checklist, at block 204 a checklist template is generated. According to aspects of the disclosed subject matter, a checklist template includes the elements necessary to generate a checklist instance upon access and execution of the template. The checklist template may include the generated checklist (reduced to checklist items to be carried out), default/generic information corresponding to all checklist instances derived from the checklist template, and the like. At block 206, the checklist template, such as checklist template 120, is stored for later use. Thereafter, routine 200 terminates.

Turning to FIG. 3, FIG. 3 is a flow diagram of an exemplary routine 300 for executing a checklist according to a checklist template, i.e., creating/generating a checklist instance and executing the corresponding checklist. Beginning at block 302, a checklist template is accessed. At block 304, a checklist instance is created according to the accessed checklist template. As discussed above, a checklist instance typically includes structured data, unstructured data, an execution status, and a checklist (or reference to a checklist) according to the information in the checklist template. At block 306, the checklist (comprising one or more checklist items within or referenced by the newly created checklist instance) is executed. At block 308, during execution of the checklist items, the checklist instance (e.g., comprising the checklist, the structured data, unstructured data, and status information) is output to a data store. Thereafter, the routine 300 terminates.

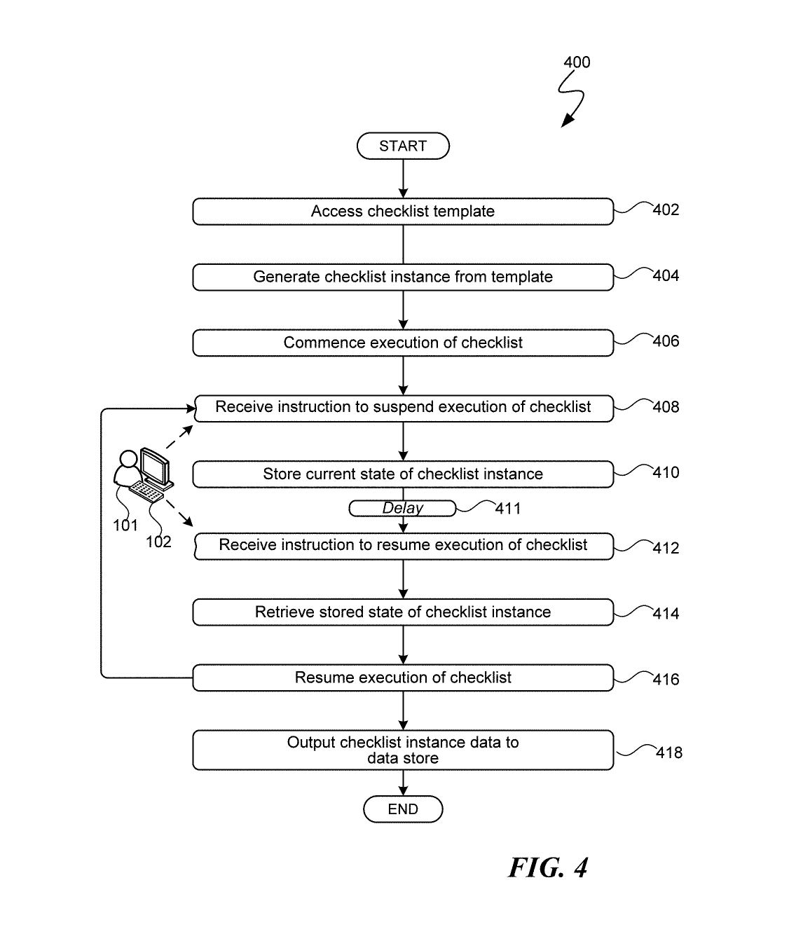

While routine 300 illustrates an overall basic process of completing a checklist according to a checklist instance, quite frequently the process of completing a checklist is interrupted, including interruptions that span more than a few moments away from the task. With this in mind, FIG. 4 is a flow diagram of an exemplary routine 400 for executing a checklist of a checklist instance according to aspects of the disclosed subject matter. Beginning at block 402, a checklist template, such as checklist template 120 of FIG. 1, is accessed. At block 404, a checklist instance is generated from the checklist template. At block 406, execution of the checklist items of the checklist is commenced. Commencing execution of the checklist items comprises executing at least one checklist item.

At block 408, an instruction is received from a computer user, such as computer user 101 by way of computer 102, is received. According to aspects of the disclosed subject matter, the instruction may be an explicit instruction by the computer user 101 to suspend execution or, alternatively, may be an implied instruction. An implied instruction may be, by way of illustration and not limitation, a result of inactivity by the user with regard to the checklist/checklist instance. At block 410, the current state of the checklist instance, including any data that has been acquired and stored in the various fields or data stores, both structured and unstructured, as well as execution state, is stored as a partially completed checklist instance. After some delay 411, at block 412 the exemplary routine 400 receives an instruction or indication from the computer user to resume execution of the checklist, according to the information in the checklist instance. Accordingly, at block 414, the stored checklist instance is retrieved and, at block 416, execution of the checklist is resumed.

As indicated in FIG. 4, additional interruptions may occur, including both short and long interruptions, as well as hand-offs from a first computer user to a second, such that from block 416 the routine 400 may return to block 408, wherein a subsequent instruction to suspend execution of the checklist is received. However, after execution of the checklist is complete, from block 416 the routine 400 proceeds to block 418 where data of the checklist instance is output to a data store. Thereafter, routine 400 terminates. Additionally, it should be appreciated that outputting data of a checklist instance may comprise outputting a completed checklist, or disseminating information regarding the checklist, or the like.

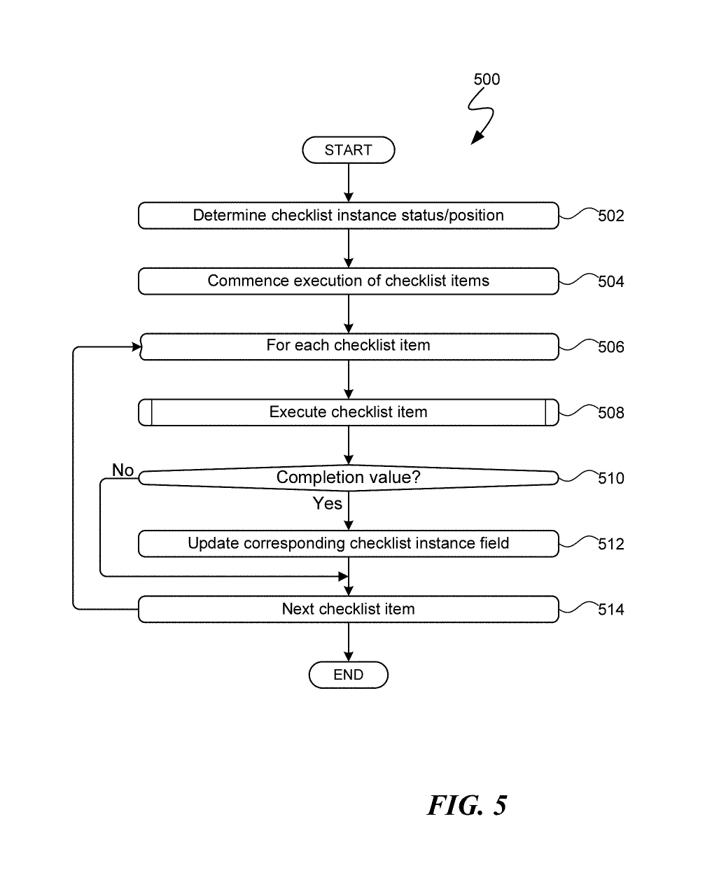

Turning to FIG. 5, FIG. 5 is a flow diagram of an exemplary routine 500 for executing checklist items of a checklist of a checklist instance in accordance with aspects of the disclosed subject matter. Beginning at block 502, a determination is made as to the current execution status of the checklist. At block 504, execution of the checklist at the determined status is commenced.

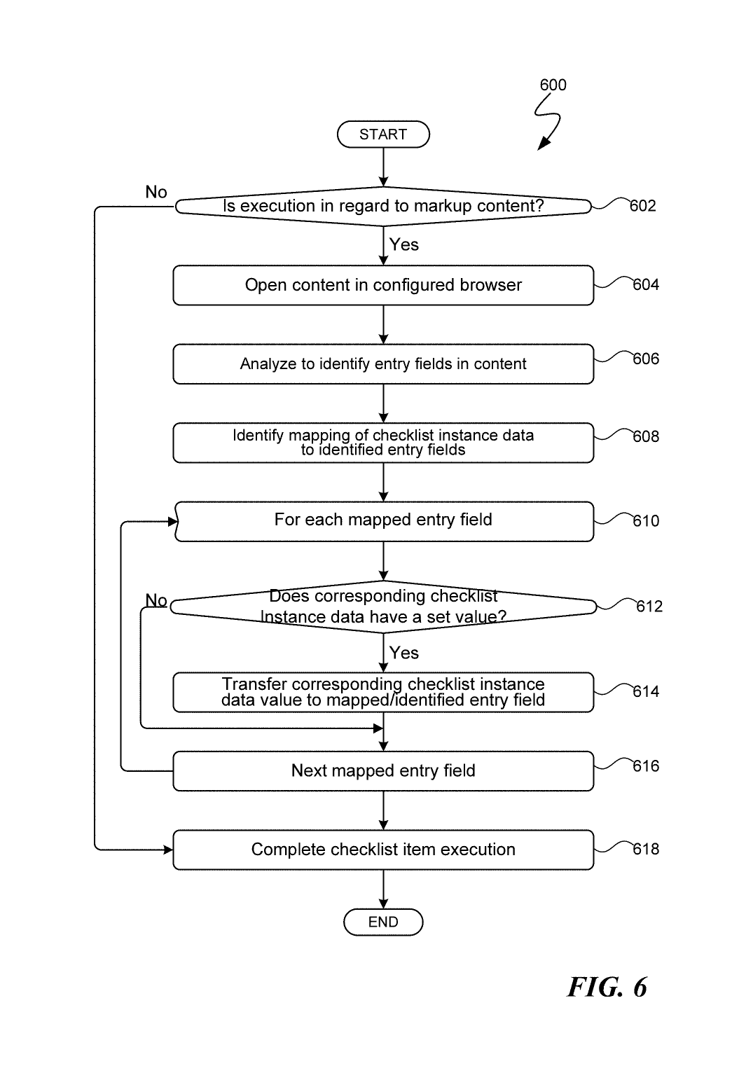

At block 506, an iteration loop is begun to iterate through each of the checklist items of the checklist, i.e., the individual actions that comprise the checklist. At block 508, a next checklist item is executed. Executing a checklist item is described in greater detail in regard to FIG. 6. Indeed, FIG. 6 is a flow diagram of an exemplary routine 600 for executing a checklist item, particularly a checklist item corresponding to auto-completion of fields of a web page, in accordance with aspects of the disclosed subject matter.

Beginning at block 602, a determination is made as to whether the execution of the current checklist item is in regard to a form or markup content (e.g., a web page, etc.) defined according to a known standard. If not, the routine 600 proceeds to block 618 where execution of the checklist item is completed without additional processing. Alternatively, if the current checklist item is in regard to markup content, the routine 600 proceeds to block 604. At block 604, the markup content that is part of the current execution is opened in a browser view that has been configured to interact with the execution of routine 600. At block 606, an examination of the content is conducted to identify entry fields within the content.

As will be appreciated by those skilled in the art, an evaluation of markup content or other structured document, particularly in regard to the various entry fields, may be made to identify a title of the field. For example and way of illustration and not limitation, in the following HTML code (markup content) there are at least two input fields, the first corresponding to a “First Name” of a person, and the second corresponding to a “Last Name” of a person.

<!DOCTYPE html>
<html>
<body>

<form action=“demo_form.asp”>
First name: <input type=“text” name=“FirstName”
value=“Mickey”/><br/>
Last name: <input type=“text” name=“LastName”
value=“Mouse”/><br/>
<input type=“submit” value=“Submit”/>
</form>
<p>Click the “Submit” button and the form-data will be sent to a
page on the server called “demo_form.asp”.</p>

</body>
</html>

Through searching for various elements of markup content (such as an HTML web page) which correspond to user input in light of the document/content type of the page, various input entry/input fields can be identified.

After identifying input fields within the markup content, at block 608, a mapping between the identified input fields of the page and the various fields within the checklist is made. This mapping may be based on similarity or exact matching between the identified input fields and the known fields within the checklist instance. Thereafter, at block 610, an iteration loop is begun to iterate through each identified input field in order to pre-populate the fields with information that is already captured and stored in the corresponding fields of the checklist instance. Thus, as part of the iteration, for each mapped input field, at block 612 a determination is made as to whether the corresponding field in the checklist instance includes a set value, i.e., whether the checklist instance has already captured and saved a value for that field. If there is a set value for the mapped field, at block 614, the value of the field is transferred from checklist instance to the mapped/corresponding input field of the content, i.e., prepopulating the input field of the content.

After transferring the value to the corresponding entry field, or if there is no set value for the entry field, at block 616 the next mapped entry field is selected and the routine 600 returns to block 610 to process the entry field. This iteration continues until, at block 616, there are no more entry fields that have been mapped to a corresponding field in the checklist instance.

After having prepopulated the entry fields of the markup content that have corresponding fields and values within the checklist instance, at block 618 the checklist item execution is completed. Completion may comprise any number of actions including, by way of illustration and not limitation: execution of a script, code, or program; awaiting submission of a form by a user; receiving data in response to a post or request; and the like. Thereafter, routine 600 terminates.

Returning again to FIG. 5, after having executed the checklist item, at block 510 a determination is made as to whether the execution has a completion value. If there is a completion value, at block 512, the corresponding checklist instance field is updated with the completion value. Thereafter, or if there is no completion value, at block 514 the next checklist item is selected as part of the iteration loop and the routine 500 returns to block 506. Alternatively, if there is no “next” checklist item, the routine 500 terminates.

Regarding routines 200-600 described above, as well as other processes described herein, such as routine 900 described below, while these routines/processes are expressed in regard to discrete steps, these steps should be viewed as being logical in nature and may or may not correspond to any specific actual and/or discrete steps of a given implementation. Also, the order in which these steps are presented in the various routines and processes, unless otherwise indicated, should not be construed as the only order in which the steps may be carried out. Moreover, in some instances, some of these steps may be omitted. Those skilled in the art will recognize that the logical presentation of steps is sufficiently instructive to carry out aspects of the claimed subject matter irrespective of any particular development language in which the logical instructions/steps are encoded.

Of course, while these routines include various novel features of the disclosed subject matter, other steps (not listed) may also be carried out in the execution of the subject matter set forth in these routines. Those skilled in the art will appreciate that the logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in regard FIG. 6 below. Additionally, in various embodiments all or some of the various routines may also be embodied in executable hardware modules including, but not limited to, system on chips (SoC's), codecs, specially designed processors and or logic circuits, and the like on a computer system.

As suggested above, these routines/processes are typically embodied within executable code modules comprising routines, functions, looping structures, selectors such as if-then and if-then-else statements, assignments, arithmetic computations, and the like. However, as suggested above, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied within applications (also referred to as computer programs), apps (small, generally single or narrow purposed applications), and/or methods, these aspects may also be embodied as computer-executable instructions stored by computer-readable media referred to as computer-readable storage media, which are articles of manufacture. As those skilled in the art will recognize, computer-readable media can host, store and/or reproduce computer-executable instructions and data for later retrieval and/or execution. When the computer-executable instructions that are hosted or stored on the computer-readable storage devices are executed by a processor of a computing device, the execution thereof causes, configures and/or adapts the executing computing device to carry out various steps, methods and/or functionality, including those steps, methods, and routines described above in regard to the various illustrated routines. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. While computer-readable media may reproduce and/or cause to deliver the computer-executable instructions and data to a computing device for execution by one or more processor via various transmission means and mediums, including carrier waves and/or propagated signals, for purposes of this disclosure computer readable media expressly excludes the transmission of the data via carrier waves and/or propagated signals.

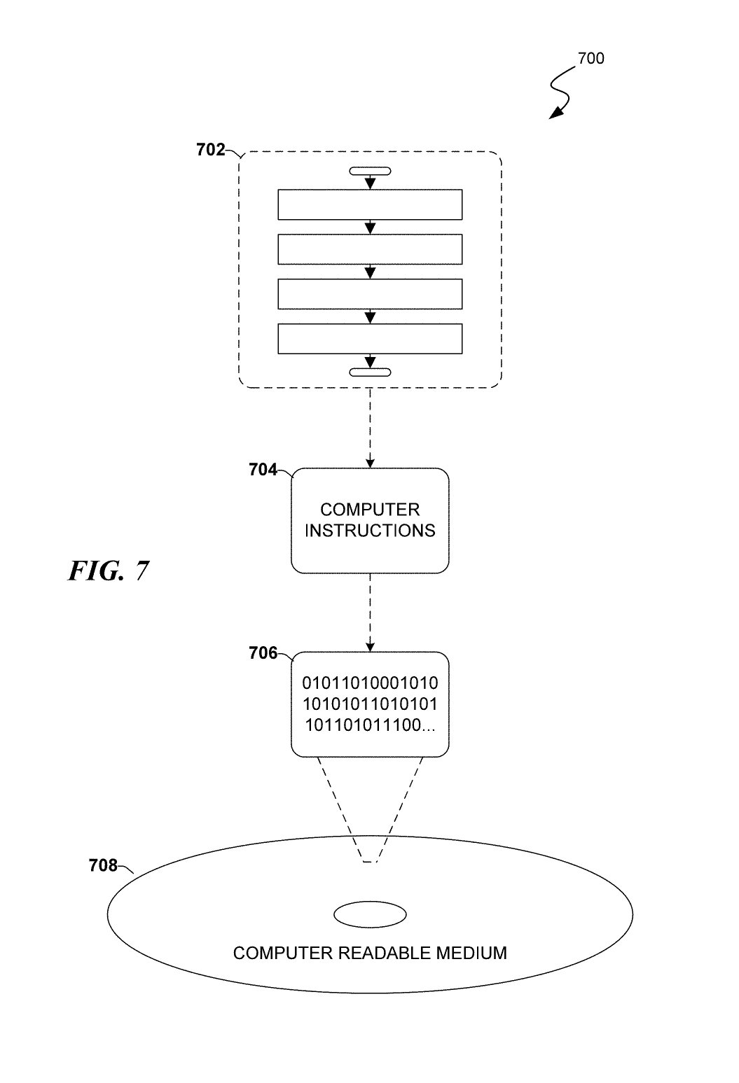

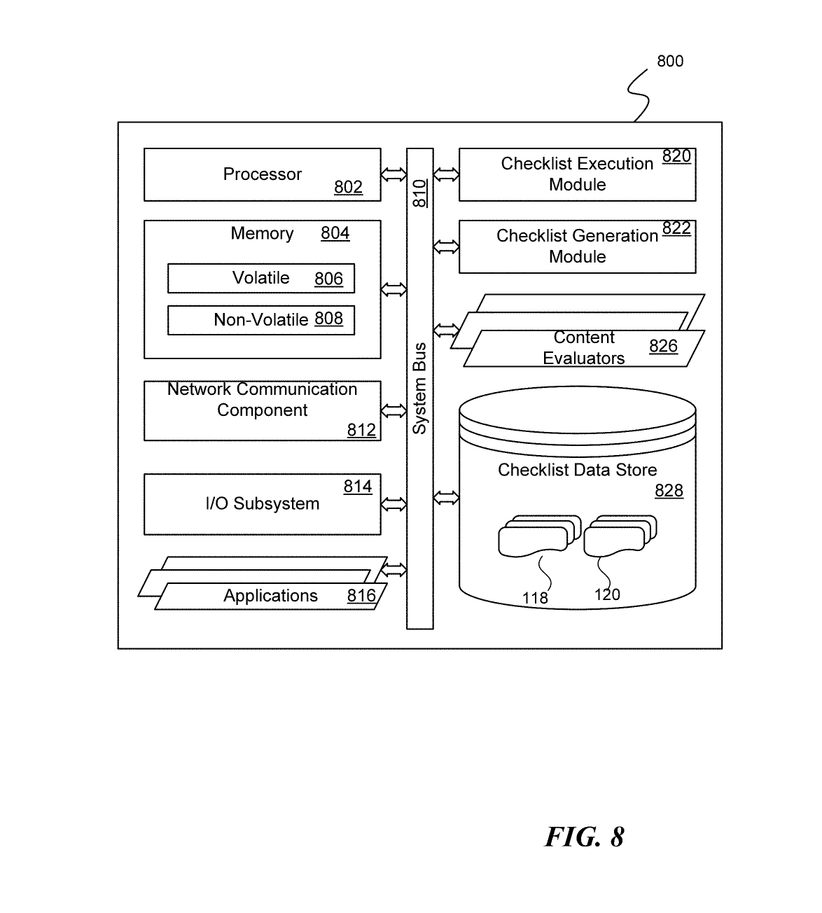

Turning to FIG. 7, FIG. 7 is a block diagram illustrating an exemplary computer readable medium encoded with instructions to configure/operate as a search engine according to aspects of the disclosed subject matter. More particularly, the implementation 700 comprises a computer-readable medium 708 (e.g., a CD-R, DVD-R or a platter of a hard disk drive), on which is encoded computer-readable data 706. This computer-readable data 706 in turn comprises a set of computer instructions 704 configured to operate according to one or more of the principles set forth herein. In one such embodiment 702, the processor-executable instructions 704 may be configured to perform a method, such as at least some of the exemplary methods 200-600 as discussed above, for example. In another such embodiment, the processor-executable instructions 704 may be configured to implement a system, such as at least some of the exemplary system 800 of FIG. 8, as described below. Many such computer-readable media may be devised by those of ordinary skill in the art that are configured to operate in accordance with the techniques presented herein.

Turning to FIG. 8, FIG. 8 is a block diagram illustrating an exemplary user computing device 800 configured according to aspects of the disclosed subject matter. The exemplary computing device 800 includes one or more processors (or processing units), such as processor 802, and a memory 804. The processor 802 and memory 804, as well as other components, are interconnected by way of a system bus 810. The memory 804 typically (but not always) comprises both volatile memory 806 and non-volatile memory 808. Volatile memory 806 retains or stores information so long as the memory is supplied with power. In contrast, non-volatile memory 808 is capable of storing (or persisting) information even when a power supply is not available. Generally speaking, RAM and CPU cache memory are examples of volatile memory 806 whereas ROM, solid-state memory devices, memory storage devices, and/or memory cards are examples of non-volatile memory 808.

The processor 402 executes instructions retrieved from the memory 404 (and/or from computer-readable media, such as computer-readable media 300 of FIG. 3) in carrying out various functions of a search engine configured to diversity search results as described above. The processor 402 may be comprised of any of a number of available processors such as single-processor, multi-processor, single-core units, and multi-core units.

Further still, the illustrated computing device 800 includes a network communication component 812 for interconnecting this computing device with other devices and/or services over a computer network, including other user devices, such as computing devices 110 and 114 as shown in FIG. 1. The network communication component 812, sometimes referred to as a network interface card or NIC, communicates over a network (such as network 108) using one or more communication protocols via a physical/tangible (e.g., wired, optical, etc.) connection, a wireless connection, or both. As will be readily appreciated by those skilled in the art, a network communication component, such as network communication component 812, is typically comprised of hardware and/or firmware components (and may also include or comprise executable software components) that transmit and receive digital and/or analog signals over a transmission medium (i.e., the network.)

The computing device 800 also includes an I/O subsystem 814. As will be appreciated, an I/O subsystem comprises a set of hardware, software, and/or firmware components that enable or facilitate inter-communication between a computer user of the computing device 800 and the processing system of the computing device. Indeed, via the I/O subsystem 814 a computer operator may provide input via one or more input channels such as, by way of illustration and not limitation, touch screen/haptic input devices, buttons, pointing devices, audio input, optical input, accelerometers, and the like. Output or presentation of information may be made by way of one or more of display screens (that may or may not be touch-sensitive), speakers, haptic feedback, and the like. As will be readily appreciated, the interaction between the computer operator and the computing device 800 is enabled via the I/O subsystem 814 of the computing device.

Also shown in the exemplary user computing device 800 are one or more executable apps and/or applications 816. These executable modules, which may include specialized applications, content browsers, word processors, and the like, as well as other external executable modules and/or services, include functionality to complete one or more checklist elements/tasks as defined by a checklist template.

The exemplary user computing device 800 further includes a checklist execution module 820. While the checklist execution module 820 may be implemented as an executable code module, an executable hardware component, a combination of the two, and the like, in execution the checklist execution module implements, by way of illustration and not limitation, much of the functionality set forth in regard to routines 400-600, in regard to and including establishing or creating a checklist instance from a checklist template, pausing and resuming the execution of a checklist with regard to a checklist instance, storing the current state of a checklist instance, such as checklist instance 118, in a checklist data store 828, and the like.

Also included in the exemplary user computing device 800 is a checklist generator module 822. As with the checklist execution module 820, the checklist generator module 822 may be implemented as an executable code module, an executable hardware component, a combination of hardware and software modules, and the like. In execution, the checklist generator module 822 is configured to generate a checklist template and storing the template in a checklist data store 828. Generating a checklist template, such as checklist template 120, as set forth in routine 200 of FIG. 2, from various content items includes generating a checklist which is described in commonly-assigned, co-pending U.S. patent application Ser. No. 14/992,569, filed Jan. 11, 2016, entitled “Checklist Generator.”

Still further, the exemplary user computing device 800 includes, or has access to, one or more content evaluators 826. These content evaluators are used by the checklist execution module 820 to parse and evaluate content, typically one content evaluator corresponding to a particular content format type, within a document/page in order to find fields that may be pre-populated, as described above in regard to routine 600 of FIG. 6.

While the checklist data store 828, content evaluators 826, and the checklist generator module 822 are shown as part of the exemplary user computer 800, in various embodiments any or all of these components may reside on an external computing device and/or be implemented as an external third-party service, such as service 112 of FIG. 1. Accordingly, the illustrated the exemplary user computer 800 should be viewed as one embodiment and illustrative but not limiting upon the disclosed subject matter.

Regarding the various components of the exemplary user computing device 800, those skilled in the art will appreciate that these components may be implemented as executable software modules stored in the memory of the computing device, as hardware modules and/or components (including SoCs—system on a chip), or a combination of the two. Indeed, as indicated above, components such as the checklist execution module 820, the checklist generation module 822, and the content evaluators 826, may be implemented according to various executable embodiments including executable software modules that carry out one or more logical elements of the processes described in this document, or as a hardware and/or firmware components that include executable logic to carry out the one or more logical elements of the processes described in this document. Examples of these executable hardware components include, by way of illustration and not limitation, ROM (read-only memory) devices, programmable logic array (PLA) devices, PROM (programmable read-only memory) devices, EPROM (erasable PROM) devices, and the like, each of which may be encoded with instructions and/or logic which, in execution, carry out the functions described herein.

Moreover, in certain embodiments each of the various components of the user computing device 800 may be implemented as an independent, cooperative process or device, operating in conjunction with or on one or more computer systems and or computing devices. It should be further appreciated, of course, that the various components described above should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computing device may be combined together or distributed across multiple actual components and/or implemented as cooperative processes on a computer network, such as network 108 of FIG. 1.

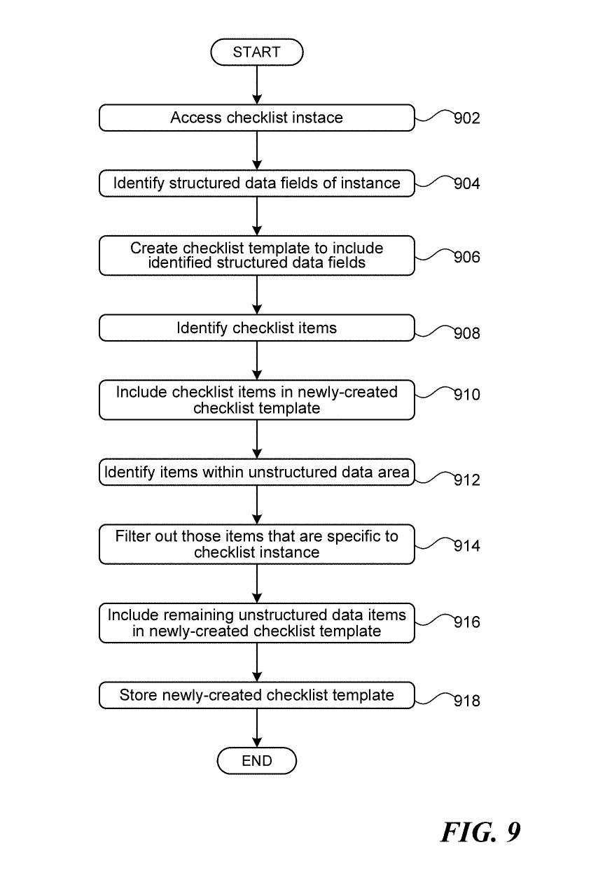

While the above discussion is made in regard to generating a checklist instance from a checklist template, according to further aspects of the disclosed subject matter a checklist template may be generated from a checklist instance. Indeed, based on information in a checklist instance, including structured and unstructured data and checklist items, an evaluation of a checklist instance may provide sufficient information that a checklist template may be generated. FIG. 9 is a flow diagram illustrating an exemplary routine 900 for creating/generating a checklist template from an existing checklist instance, according to aspects of the disclosed subject matter. Beginning at block 902, a checklist instance is accessed. The checklist instance may be a completed checklist instance (i.e., all of the checklist items have been executed and/or carried out), a new checklist instance for which none of the checklist items have been executed, or in some state in between the two. Illustratively, the checklist instance may have been generated at the direction of a user from a written checklist, as described in co-pending and commonly-assigned patent application Ser. No. 14/992,569, filed Jan. 11, 2016, entitled “Checklist Generation.”

At block 904, the structured data fields of the checklist instance are identified. Identification includes at least identifying the data type (e.g., an integer, a character string, a Boolean value, and address, etc.) as well as the meaning of the value (e.g., the identified data field contains an address, a first name, employee number, etc.) At block 906, a checklist template is created to include the identified data fields (of the structured data). At block 908, the checklist items of the checklist instance are identified and, at block 910, the checklist items are included/added to the newly-created checklist template.

At block 912, the data items stored in the unstructured data area are identified. At block 914, those items that pertain specifically to the checklist instance, as contrasted to those items that are generic to the checklist instance, are filtered out and, at block 916, the remaining unstructured data items are stored in the unstructured data area of the checklist template. At block 918, the newly-created checklist template is stored for future use, typically in a data store storing one or more checklist templates. Thereafter, the exemplary routine 900 terminates.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A computer-implemented method for executing a checklist according to a checklist instance, the method comprising:
creating a checklist instance from a checklist template, the checklist instance comprising one or more checklist fields and a checklist comprising a plurality of checklist items;
executing at least a first checklist item of the plurality of checklist items, wherein execution of the first checklist item causes an update to a first checklist field;
receiving a first instruction to suspend execution of the checklist, and in response:
storing the current state of the checklist instance in a data store, wherein storing the current state of the checklist instance in a data store comprises storing the first checklist field as part of the checklist instance; and
suspending execution of the checklist instance; and
receiving a second instruction to resume execution of the checklist with regard to the checklist instance, and in response:
retrieving the checklist instance from the data store; and
executing at least one additional checklist item of the checklist.

2. The computer-implemented method of claim 1, wherein the checklist template comprises a source checklist, and wherein checklist of the checklist instance corresponding to the source checklist.

3. The computer-implemented method of claim 2, wherein the checklist template comprises data for creating one or more checklist fields in the checklist instance, including the first checklist field.

4. The computer-implemented method of claim 3, wherein the checklist template comprises data for establishing an initial value in the first checklist field upon creation of the checklist template.

5. The computer-implemented method of claim 3, wherein the checklist template comprises data for creating an unstructured data store in the checklist instance.

6. The computer-implemented method of claim 5, wherein the checklist template comprises content to be included in the unstructured data store in the checklist instance upon creating the checklist instance.

7. The computer-implemented method of claim 5, wherein checklist instance further comprises an execution state indicating the current execution state in the checklist.

8. The computer-implemented method of claim 7 further comprising receiving an instruction to store content in the unstructured data store of the checklist instance, and storing the content in the unstructured data store of the checklist instance.

9. The computer-implemented method of claim 7, wherein executing at least one checklist item of the plurality of checklist items comprises:
determining that the execution of the at least one checklist item is in regard to markup content;
analyzing entry fields in the markup content to identify entry fields of the markup content;
correlating an identified entry field of the markup content to a checklist field of the checklist instance; and
prepopulating the entry field of the markup content with the current value of the checklist field.

10. A computer-readable medium bearing computer-executable instructions which, when executed on a computing system comprising at least a processor retrieved from the medium, carry out a method comprising:
creating a checklist instance from a checklist template, the checklist instance comprising one or more checklist fields to be set and further comprising a checklist comprising a plurality of checklist items;
executing at least a first checklist item of the plurality of checklist items, wherein execution of the first checklist item causes an update to a first checklist field;
receiving a first instruction to suspend execution of the checklist, and in response:
storing the current state of the checklist instance in a data store, wherein storing the current state of the checklist instance in a data store comprises storing the first checklist value as part of the checklist instance; and
suspending execution of the checklist instance; and
receiving a second instruction to resume execution of the checklist with regard to the checklist instance, and in response:
retrieving the checklist instance from the data store; and
executing at least one additional checklist item of the checklist;
wherein executing a checklist item of the checklist comprises:
determining that the execution of the at least one checklist item is in regard to markup content;
analyzing the markup content to identify entry fields of the markup content;
correlating an identified entry field of the markup content to a checklist field of the checklist instance; and
prepopulating the entry field of the markup content with the current value of the checklist field.

11. The computer-readable medium of claim 10, wherein the checklist template comprises a source checklist, and wherein checklist of the checklist instance corresponding to the source checklist.

12. The computer-readable medium of claim 11, wherein the checklist template comprises data for creating one or more checklist values in the checklist instance, including the first checklist value.

13. The computer-readable medium of claim 12, wherein the checklist template comprises data for establishing an initial value in the first checklist value upon creation of the checklist template.

14. The computer-readable medium of claim 12, wherein the checklist template comprises data for creating an unstructured data store in the checklist instance.

15. The computer-readable medium of claim 14, wherein the checklist template comprises content to be included in the unstructured data store in the checklist instance upon creating the checklist instance.

16. The computer-readable medium of claim 14, wherein checklist instance further comprises an execution state indicating the current execution state in the checklist.

17. The computer-readable medium of claim 16, further comprising receiving an instruction to store content in the unstructured data store of the checklist instance, and storing the content in the unstructured data store of the checklist instance.

18. The computer-readable medium of claim 10, wherein the markup content is a HyperText Markup Language (HTML) document.

19. The computer-readable medium of claim 10, wherein the markup content is an Extensible Markup Language (XML) document.

20. A computer system for processing a checklist instance, the system comprising a processor and a memory, wherein the processor executes instructions stored in the memory as part of or in conjunction with additional components, the additional components comprising:
a checklist execution module which, in operation:
generates a checklist instance from a checklist template;
executes at least a first checklist item of a checklist of the checklist instance;
receives an instruction to suspend the execution of the checklist, and in response:
stores the current state of the checklist instance and suspends execution of the checklist;
receives an instruction to resume the execution of the checklist, and in response:
retrieves the stored state of the checklist instance and resumes execution of the checklist;
wherein resuming the execution of the checklist comprises executing at least a second checklist item of the checklist.
